(19) United States
(12) Patent Application Publication
(10) Pub. No.: US 2024/0046795 A1
(43) Pub. Date: Feb. 8, 2024

(54) A TRAFFIC RISK MANAGEMENT SYSTEM

(71) Applicant: Norman BOYLE, Merimbula, New South Wales (AU)

(72) Inventor: Norman BOYLE, Merimbula, New South Wales (AU)

(21) Appl. No.: 18/266,346

(22) PCT Filed: Dec. 10, 2021
(86) PCT No.: PCT/AU2021/051475

§ 371 Date: Jun. 9, 2023

(30) Foreign Application Priority Data
Dec. 10, 2020 (AU) 2020904585

(51) Int. Cl. G08G 1/16; G08G 1/04; G08G 1/01

(52) U.S. Cl. CPC G08G 1/166; G08G 1/04; G08G 1/0133

(57) ABSTRACT

Disclosed herein is a traffic risk management system for monitoring vehicles relative to one or more workers. The system comprises a driverless traffic management vehicle for detecting one or more of a location, speed and trajectory of an approaching vehicle and a personal detection device mountable on the or each worker and configured to receive a signal from the driverless traffic management vehicle. The driverless traffic management vehicle sends an alert to the personal detection device mounted on the or each worker if the detected location, speed and/or trajectory of the approaching vehicle exceeds a predetermined threshold value measured relative to the or each worker.

### TECHNICAL FIELD

The present invention relates generally to a traffic risk management system useful in embodiments for monitoring the safety of personnel working in close proximity to traffic comprising vehicles.

### BACKGROUND

Safety in the workplace is something that is taken seriously. Across the world there are various pieces of national legislation that require certain safety standards to be met by operators responsible for workers. From 2003 to 2018 in Australia, over 3,700 workers were fatally injured while working. These fatalities can be a result of an injury sustained (worker fatality) or as a result of someone else's work activity (bystander fatality).

Year on year, a statistical analysis of workplace fatalities shows that the number of deaths in Australia is falling. This is likely a result of (amongst other things) good workplace education, strict forced compliance with Occupational Health and Safety (OH&S) rules and improved personal protective equipment.

Some workers are exposed to risks simply due to the nature and location of their work. For example, construction workers are on construction sites where there are e.g. dangerous powered tools, unsafe partially built structures and large heavy loads being moved from one location to another. Other workers must work on roadways, where the danger comes from vehicles moving along the roadway as general public traffic including cars, motorbikes and public transport. Traffic management measures are put into place where workers are close to the road to reduce the likelihood that there will be a vehicular-related fatality. It is typical for the speed of vehicles on roads where workers are operating to be reduced, there can be signage displayed to warn drivers to be careful and/or there can be detours or road closures to steer traffic away from the worker's locations. These measures are at least partially successful, but they each rely on warning or controlling the actions of the vehicle driver, rather than warning or controlling the actions of the worker himself. If the worker can also be alerted to any potential danger then there is a two-pronged approach to safety (targeting the driver and targeting the worker themselves) that could possibly further decrease the likelihood of an accident or fatality.

There is always room for improvement when it comes to traffic risk management as it relates to worker safety. There is a need for improved systems, improved personal protective equipment and any other means that can quickly and efficiently alert a worker if there is danger in their vicinity.

### SUMMARY OF INVENTION

In a first aspect there is provided a traffic risk management system for monitoring vehicles relative to one or more workers. The system comprises a driverless traffic management vehicle for detecting one or more of a location, speed and trajectory of an approaching vehicle, and a personal detection device mountable on the or each worker and configured to receive a signal from the driverless traffic management vehicle. In use, the driverless traffic management vehicle sends an alert to the personal detection device mounted on the or each worker if the detected location, speed and/or trajectory of the approaching vehicle exceeds a predetermined threshold value measured relative to the or each worker. The predetermined threshold value is indicative of the detected vehicle being at a location, travelling at a speed and/or moving in a trajectory that presents risk of harm to the or each worker.

Systems for detecting the proximity of vehicles and equipment being used on a worksite to workers not in vehicles on the worksite are known. Such systems may make use of hardware in the vehicles that monitors the relative locations of the vehicle and workers and, should the vehicle come too close to a worker, the worker (and the vehicle's operator) can be alerted and remedial action can be taken. The worker can immediately move away from any clear and present danger that comes to their attention, and the operator can stop the vehicle or direct it away from the worker. This arrangement can work well on sites where there are multiple workers and mobile plant and equipment that are being operated by trained operator professionals. Each professional operator will be familiar with the alert and will understand immediately that, if the alert is activated, a worker is in danger.

However, not all vehicles that pose a danger to workers are operated by trained operator professionals. Some vehicles are driven by members of the public that are driving down public roadways along-side or through worksites. These public vehicles can in some instances be more dangerous than large, heavy worksite vehicles because the public driver may not be aware of the danger posed to a worker. The lay-person driver might not know that there are workers nearby, and even if they know there is danger, they may not fully appreciate the extent of risk posed to the worker by their particular vehicle. It is not possible or practical to attach hardware to each public vehicle moving along a roadway in order to allow the monitoring of the vehicle/worker distance relationship. It would be impractical and expensive to require modification of every public vehicle to include a specific device hardware that could communicate with a worker personal detection device despite that it would improve safety.

By making use of the driverless traffic management vehicle, the present invention can overcome or at least ameliorate the problem of vehicles that are not adapted to communicate with worker personal protection devices being in proximity to work zones. The driverless traffic management vehicle can be located at various positions around the worksite where it can detect the oncoming vehicular traffic. Each vehicle that approaches the worksite can be categorised according to its location, speed and/or trajectory, for example. If a vehicle deviates from an expected location, speed and/or trajectory, this can be noted by the driverless traffic management vehicle and more detail can be gathered. If the vehicle continues to behave outside of certain parameters, then danger for the worker could be imminent, and an alert protocol could be activated. The driverless traffic management vehicle may then initiate an alert signal which will be sent to the worker's personal detection device.

The driverless traffic management vehicle can be an autonomous vehicle. It should be noted that the term “autonomous” should not necessarily always be construed literally herein in that the unmanned vehicle may not be entirely autonomous wherein, certain operational aspects of the unmanned vehicle may be human controlled including by remote control or pre-programming such that the unmanned vehicle may be semiautonomous. The autonomous vehicle may be a land-based vehicle. The autonomous vehicle can be an aerial vehicle. Where the vehicle is a wheeled vehicle, the wheeled vehicle can have a vehicular chassis operably engaging controllable driven and steerable wheels and defining sides, a first end and a second opposite end. The autonomous vehicle can be an aerial vehicle. The unmanned aerial vehicle (UAV) can be a drone. The drone can comprise a frame with a fuselage and one or more wings arranged in a symmetrical location around the fuselage.

There can be any number of driverless traffic management vehicles deployed around the area where the workers are located. Preferably, there is at least one driverless traffic management vehicle for every 100, 200, 300, 400 or 500 m 3 of worksite. Where there is more than one driverless traffic management vehicle, each vehicle may be in communication with the other vehicles, so that they can space themselves accordingly to provide a wider catchment area of approaching vehicle detection. For example, each driverless traffic management vehicle may be spaced at least 20 m, 40 m, 60 m, 80 m, 100 m, 200 m, 300 m, 400 m or 500 m (or more, depending on factors such as the likely approach speed of oncoming vehicles) from another driverless traffic management vehicle.

Where more than one driverless traffic management vehicle is deployed, these may be deployed at staged distances from the work zone (and hence the workers), in order for them to provide a more effective protection. For example, the driverless traffic management vehicle or vehicles may be deployed at a distance of 20 m, 40 m, 60 m, 80 m, 100 m, 200 m, 300 m, 400 m, 500 m, 600 m, 700 m, 800 m, 900 m, 1,000 m (or more, depending on factors such as the likely approach speed of oncoming vehicles) from the closet worker. The driverless traffic management vehicle can determine the location of each worker by detecting the signal emitting from the personal detection device mounted on the worker as described in more detail below. Driverless traffic management vehicles may be positioned (e.g. in a stationary configuration) at appropriate distances from a work zone in which workers are working. For example, the driverless traffic management vehicles may be positioned 200 m, 500 m and 1 km away from the work zone. Where multiple vehicles are deployed, these may communicate with each other to detect relative changes in a particular approaching vehicle's location, speed and/or trajectory.

Both the driverless traffic management vehicle and the personal detection device may comprise a network interface configured for sending and receiving data, including for sending location data representing their respective locations. In embodiments, the network interface may be a long-range network interface, such as a cellular network interface so as to be able to send and receive data across several kilometres. Typically, highways where workers are operating have sufficient cellular coverage so such a system may be suitable in these embodiments. For rural application where cellular coverage is intermittent other long-range radio communication may be employed.

In some rural applications where cellular coverage is unavailable, the driverless traffic management vehicle may be configured for communicating directly with the personal detection device such as by a suitable long-range radio data channel. In this embodiment, the long-range radio data channel may be configured for transmitting data across several kilometres so as to be suited for communicating with the driverless traffic management vehicle in a wide range of scenarios. In this embodiment, the driverless traffic management vehicle may comprise a radio data channel connectivity status indicator so as to prompt the worker or their supervisor if the driverless traffic management vehicle falls out of data communication range. In embodiments, the driverless traffic management vehicle and the personal protection device may communicate using an 802.11 ad hoc Wi-Fi network.

In some embodiments, the driverless traffic management vehicle may be battery-powered. Optionally, the driverless traffic management vehicle may further comprise solar panelling, so as to recharge the batteries. In some embodiments, the driverless traffic management vehicle may further comprise an electronic signage board facing towards oncoming traffic. The board can be for displaying any type of signage. The signage might be to warn the vehicles in the approaching traffic to slow down. The signage could be for warning the oncoming traffic that their speed, location, trajectory, and or other parameters are being measured.

In order to deploy the driverless traffic management vehicle, it can be driven to the location at which it will operate and then set to autonomous mode and deployed. In some embodiments, each driverless traffic management vehicle is assigned a zone in which it may operate, and it does not pass the borders of that zone during deployment. In some embodiments, each zone is designed so that there is at least one driverless traffic management vehicle located on each pathway leading towards of the worksite where the workers are located. In some embodiments, the driverless traffic management vehicle is not assigned to a zone. Instead, each driverless traffic management vehicle is able to roam around the area where the workers are located in order to locate any traffic that is in their vicinity. The driverless traffic management vehicle can learn where the traffic is most likely to come from and may locate itself there.

In some embodiments, the unmanned driverless traffic management vehicle is programmed with a route configuration. The setting may be a following route offset configuration setting such that the unmanned vehicle may be configured for following a maintenance machine and wherein the actual route may be a waypoint route of the maintenance machine.

The driverless traffic management vehicle can be adapted to detect its surroundings. The driverless traffic management vehicle may have a vision sensor subsystem for detecting its surroundings. The vision sensor subsystem may be configured for determining the actual lateral offset of the autonomous unmanned vehicle with respect to a road verge using image recognition. The image recognition may be configured for recognising at least one of a verge line, centre line, and roadside barrier. The vision sensor subsystem may be configured for interpolating between broken sections of the centre line. The road verge lateral offset configuration setting may comprise at least one of an on-road and off-road setting and an offset distance. The unmanned driverless traffic management vehicle further may comprise object avoidance capabilities. The object avoidance capabilities may comprise the image subsystem using image recognition. The image recognition may comprise recognising known roadside furniture. The object avoidance capabilities may comprise the unmanned driverless traffic management vehicle comprising an object detector. The object detector may comprise an object proximity sensor. The object proximity sensor may comprise at least one of an ultrasonic and Lidar sensor. The object detector may comprise a bump sensor. The system may be configured for selecting the unmanned vehicle formation configuration settings in accordance with a maintenance plan selection.

In embodiments, the methods employed for the driverless traffic management vehicle to detect and move within its surroundings are described in AU2017100463 or AU2019333837 the entire contents of both of which are hereby incorporated by reference.

A vehicle having a deployable crash attenuator, such as that described in AU2019333837, can be positioned on the road ahead of a worksite in a usual manner. The attenuator vehicle can comprise a deployable crash attenuator deployed downwardly on a pivot mechanism so as to expose a rearward impact face and optionally signage. Such an attenuator vehicle can therefore provide a first line of defence should any vehicle that breaches the normal behaviour of a vehicle on the roadway head towards the worksite. In some embodiments, at least one of the driverless traffic management vehicles is such an attenuator vehicle.

Alternatively, or in addition, at least one of the driverless traffic management vehicles may be the vehicular signage done described in AU2017100463. Such drones are more general purpose than an attenuator vehicle and may therefore be deployed in a wider variety of locations than the attenuator vehicle (which has a secondary purpose, namely to absorb the impact of vehicles that are likely to crash into a worksite).

The driverless traffic management vehicle can detect one or more of location, speed and trajectory of an approaching vehicle. The driverless traffic management vehicle first determines that an object approaching is a vehicle. Once it is confirmed that it is a vehicle, details can be collected about the vehicle, including its speed. The vehicle once detected can be referred to as a detected vehicle. The same vision sensor subsystem for detecting the surroundings can be used for detecting the approaching vehicle. The vision sensor subsystem can comprise an image capture device adapted to capture image or video data of the surrounds of the driverless traffic management vehicle for the subsequent processing as will be described in further detail below. In embodiments, the vision sensor subsystem comprises side facing cameras so as to view sideways from the driverless traffic management vehicle at the road verge. In other embodiments, the cameras may be forward-facing but wide angled so as to be able to view the road verge and other indica at differing offsets.

The driverless traffic management vehicle can comprise a location sensor subsystem. The location sensor subsystem can detect the location of an approaching vehicle. The location sensor subsystem may make use of some of the features of the vision sensor subsystem. The location of the vehicle can be determined and then measured relative to the location of the worker(s). The driverless traffic management vehicle can include a map on which it plots both the approaching vehicle and the worker(s). The location(s) of each object can be analysed and then it can be determined if the location of the detected vehicle is closer than a predetermined threshold for what is considered a safe distance for a worker relative to that detected vehicle. If the distance from the worker is greater than a value X, then the vehicle is not a hazard and can be allowed to continue on its way. If the distance from the worker is less than a value X then the vehicle may be or may become a hazard and an alert might be required. The alert sent could be configured to warn the worker that they are inadvertently moving towards the vehicle when they do not intend to be moving in that direction. The relative distances will depend on the worksite and the likely speed at which vehicles will be approaching. In highway environments, for example, where vehicles might be approaching at a speed in excess of 100 km/h, then an alert may be provided whilst the vehicle is still hundreds of meters away. In urban environments, where oncoming vehicles are likely to be moving much slower (e.g. at 40 km/h), an alert at 50 m may be sufficient. If an approaching vehicle is considered particularly hazardous then all workers on the worksite might receive an alert. Alternatively, only those workers that are within the prescribed distance (and have therefore breached the threshold) might receive an alert. A supervisor might also receive an alert to make sure that workers under their control are following guidelines.

The driverless traffic management vehicle can comprise a speed sensor subsystem. The speed sensor subsystem can detect the speed of an approaching vehicle. The speed sensor subsystem may make use of some of the features of the vision sensor subsystem. The speed of the vehicle can be measure against the predetermined threshold for what is considered a safe speed for a vehicle in relation to its distance to a worker. If the distance from the worker is greater than a value X, then a speed of Y might be acceptable. If the distance from the worker is less than a value X then a speed of Y might be unacceptable. In some embodiments, a speed that exceeds a predetermined threshold will cause the generation of an alert to all the workers in the vicinity, notwithstanding their distance from the vehicle travelling at that speed. For example, if a vehicle is travelling at a speed above the prescribed speed limit by more than 5, 10, 15 or 20% then all workers will receive an alert to let them know that there is a fast moving vehicle in their area. In some embodiments, if a vehicle is traveling faster than 80, 90, 100 km/h then all workers will receive an alert to let them know that there is a fast-moving vehicle in their area.

The driverless traffic management vehicle can be configured to capture the licence plate of vehicles that cause the generation of an alert so that the details can be forwarded to the relevant authorities if appropriate. The licence plates of all vehicles can be captured for later data analytics as required (with appropriate privacy laws being strictly adhered to). For example, the licence plate might be used to characterise a particular approaching vehicle so that any changes in its location, speed and/or trajectory can be noted by subsequent driverless traffic management vehicles.

The driverless traffic management vehicle can comprise a trajectory sensor subsystem. The trajectory sensor subsystem can detect the trajectory of an approaching vehicle. The trajectory sensor subsystem may make use of some of the features of the vision sensor subsystem. The trajectory of the vehicle can be determined based on its speed and location at a first point relative to its speed and location at a second point. The trajectory for the detected vehicle that is predicted can be measured relative to the known location(s) of the worker(s). The location(s) can be measured and then it can be determined if that location is a risk given the predicted trajectory. If the trajectory means that the vehicle will pass the worker at a distance greater than a value X, then the vehicle is determined as not a likely hazard and can be allowed to continue on its way. If the trajectory means that the distance from the worker will be less than a value X then the vehicle may be or become a hazard and an alert might be required. The predicted trajectory can take into account the usual corners and passageways that the vehicles are taking on the road. The driverless traffic management vehicle will be considering outlier data where vehicles have unusual trajectories, even when they are moving at low speeds. For example, a vehicle may have followed an incorrect pathway around the roadwork obstacles and may be on an unintended pathway inside the worksite. An alert can be sent to all workers on the site if a detected vehicle appears to be posing a risk. An alert can be sent only to the workers that are at risk due to the vehicle with the unexpected or hazardous trajectory.

The speed sensor subsystem, location sensor subsystem and trajectory sensor subsystem can all be processed by a vehicle management interface onboard the driverless traffic management vehicle. The vehicle management interface also stores the predetermined threshold information set by the operator/user. In embodiments, the driverless traffic management vehicle may by operable or monitorable via a graphical user interface operable by an operator/user. Such an interface may be provided by way of a portable computing device have an appropriate display. The operator may be able to control the aspect of the driverless traffic management vehicle remotely. Where there is more than one device, the operator may be able to control the formation of the driverless traffic management vehicles. For example, if there is a particular hazard, the operator may be able to direct one or more (or all) of the driverless traffic management vehicles to that hazard for priority monitoring.

The personal detection device (PDD) monitors workers and their positions. Where the personal detection device is used in relation to a vehicle having hardware attached to it (as in the background art), the personal detection device can use a Time of Flight (ToF) principle. The Time-of-Flight principle (ToF) is a method for measuring the distance between a sensor and an object, based on the time difference between the emission of a signal and its return to the sensor, after being reflected by an object.

Each personal detection device in the present invention is configured to indicate the location of the device based on a gyroscope measurement, inertial sensor measurement and/or a GPS signal. The location of the device should be the location of the worker. Furthermore, each personal detection device is configured to receive an alert from the driverless traffic management vehicle by being connected with it. The alert is received wirelessly.

The device can comprise a series of status LEDs which let the user know when the device is activated and or when the device requires e.g. charging. The device can also have an indicator to let the worker know that it is active and able to receive an alert (despite that it is silent). Optionally, there can be an indicator to let the worker know if an alert has been received.

The personal detection device is mountable on the worker. The device can, for example, be incorporated into the workers clothing. The device can, for example, be worn on the worker's body. Notwithstanding how the device is mounted, it should be in a position that the worker can detect the alert when it is activated. In an embodiment, the personal detection device has a clip for mounting on the users' belt.

The alert can be visual and or audible. In an embodiment, the worker is alerted via a series of beeps, flashes and or vibrations from the device. The worker can take immediate action upon receiving an alert. In some instances, if the alert is a false alarm and or the user is satisfied that the risk has passed or is not as dangerous as first thought, the user can cancel the alert. A supervisor can be informed if an alert is cancelled.

Where the alert is visual, the indicator can be flashes of coloured lights from an LED. The LED colours can be user configurable if required. The colours can show escalating risk if required. For example, a red flashing LED light can indicate that there is an immediate danger, and the worker needs to stop what they are doing and check their surroundings. An amber flashing LED light can indicate that there may be a danger, but further assessment is being made, so the worker should be ready to take action. A green flashing LED light can mean that there is no danger and may be provided (optionally) if the worker wishes to seek reassurance that there are no risks to safety being indicated from the driverless traffic management vehicles. Alternatively (or in addition), a strobe light could be provided, such being likely to be immediately noticed.

Where the alert is audible, the sound can be beeps or sirens or other ringing tones that attract attention. The user can select a sound that can be heard over background noises. The sound can change according to the present risk. For example, short alarming intermittent beeps can indicate that there is an immediate danger and the worker needs to stop what they are doing and check their surroundings. A series of longer beeps can indicate that there may be a danger, but further assessment is being made, so the worker should be ready to take action. A beep can be emitted every 5, 10, 15 minutes if preferred, which can mean that there is no danger. This optional reassurance beep can be set if the worker wishes to seek reassurance that there are no risks to safety being indicated from the driverless traffic management vehicles.

The alert can be a vibration. The vibration can complement the visual and audible beep. The vibration can be useful if the worker is in an area that is noisy and or where they cannot see the device. The vibration should be transferred to the worker's body to get their attention (e.g. by being mounted to the worker's arm or belt). The intensity of the vibration can change according to the present risk. For example, intense and persistent vibrations can indicate that there is an immediate danger and the worker needs to stop what they are doing and check their surroundings. A soft intermittent vibration can indicate that there may be a danger, but further assessment is being made, so the worker should be ready to take action. A short soft vibration can be emitted every 5, 10, 15 minutes if preferred which can mean that there is no danger. This optional reassurance vibration can be set if the worker wishes to seek reassurance that the device is working properly, and that there are no risks to safety being indicated from the driverless traffic management vehicles.

The vehicle detected can include any vehicle travelling along the roadway including car, motorbike, truck, bus or other. Any vehicle that could pose a hazard to a worker is included within the scope.

In a further aspect there is provided a method of monitoring the health and safety of workers located at a worksite adjacent to traffic, the method comprising the steps of:
a. programming or causing to have programmed one of more driverless traffic management vehicles to detect traffic hazards in the vicinity of the worksite;
b. deploying the said one or more driverless traffic management vehicles in the vicinity of the worksite;
c. allowing an alert to be initiated by one or more of the driverless traffic management vehicles during use if a traffic hazard is detected based on its programming; and
d. providing workers with a personal detection device configured to receive the alert issued by the one or more of the driverless traffic management vehicles.

The step of programming can comprise the operator programming the driverless traffic management vehicle. Alternatively, the device is provided pre-programmed or with various pre-programmes that can be selected. In the vicinity of the worksite means within a reasonable distance of each of the workers such that they are still able to receive the alerts and the hazards are relevant to their locations.

### BRIEF DESCRIPTION OF THE FIGURES

Embodiments of the invention will now be described with reference to the accompanying drawings which are not drawn to scale and which are exemplary only and in which:

FIG. 1 is a plan view of an embodiment of the traffic risk management system.

FIG. 2 is a plan view of an alternative embodiment of the traffic risk management system.

FIG. 3 is a plan view of yet another alternative embodiment of the traffic risk management system.

FIG. 4 is an embodiment of the alert system.

FIGS. 5A and 5B are embodiments of the personal detection device.

### DETAILED DESCRIPTION OF EMBODIMENTS OF THE INVENTION

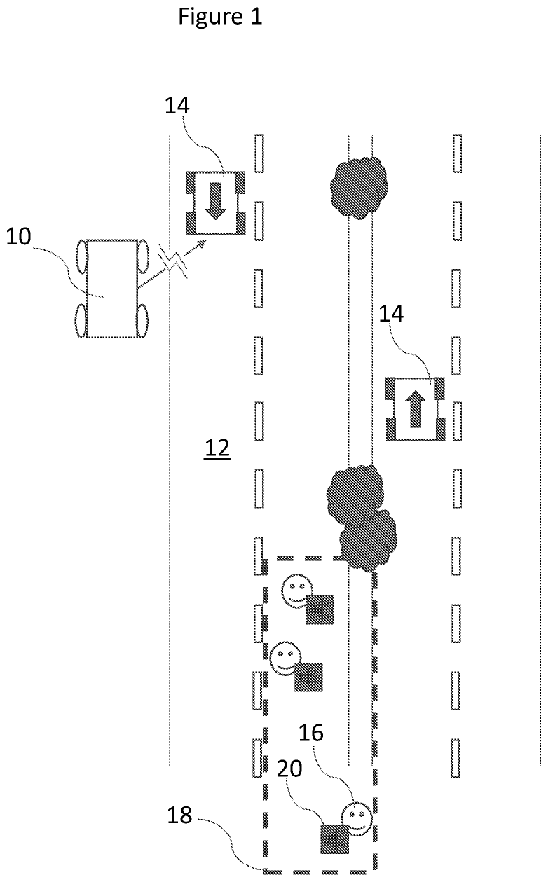

FIG. 1 is a schematic showing how an embodiment of the traffic risk management system could be implemented. A driverless traffic management vehicle 10 is located adjacent to a roadway 12. The driverless traffic management vehicle 10 is for detecting one or more of location, speed and trajectory of a vehicle 14 travelling along the road 12. A line is shown from the driverless traffic management vehicle 10 to the moving vehicle 14 but it should be understood that this is a signal detection and there is nothing visual to be seen. As the vehicle 14 moves along the road 12, the line from the driverless traffic management vehicle 10 to the vehicle will change as the distance changes. The variable distance of the signal from the driverless traffic management vehicle 10 to the vehicle is shown schematically in FIG. 1. It should be understood that this variable distance also applies to the other figures. A plurality of workers 16 are shown in worksite 18 (denoted by dotted lines). Each worker 16 is associated with a personal detection device 20. In its simplest form, if driverless traffic management vehicle detects that vehicle 14 is travelling too fast (e.g. 100 kmph) past the worksite 18, then an alert will be sent to each personal detection device 20 to warn the workers 16.

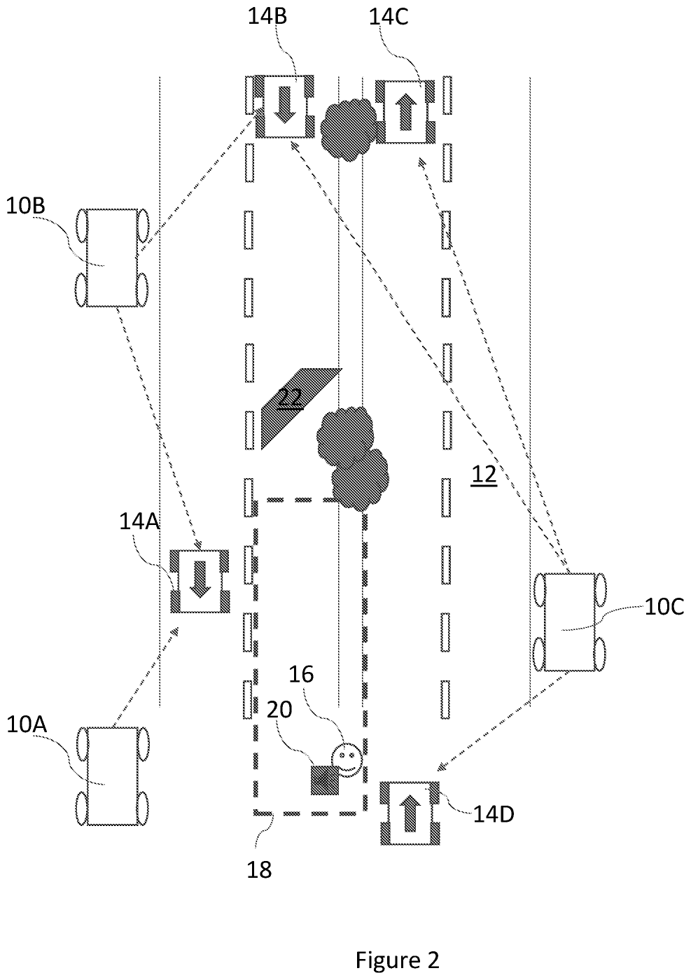

FIG. 2 shows three driverless traffic management vehicles 10A, 10B, 10C deployed around the area 18 where the workers 16 are located. Each of the driverless traffic management vehicles is in communication with the other driverless traffic management vehicles, so that they can space themselves accordingly to provide a wider catchment area of approaching vehicle 14 detection. In FIG. 2, vehicles 10A, 10B and 10C have spaced themselves from one another approximately equidistantly. Notwithstanding the spacing from one another, each vehicle 10 remains within detection distance of workers 16 in worksite 18.

Each driverless traffic management vehicle 10A, 10B, 10C can detect one or more of location, speed and trajectory of an approaching vehicle 14A, 14B, 14C, 14D. The arrows in FIG. 2 show how each driverless traffic management vehicle 10 is measuring details from each vehicle 14 on roadway 12. As vehicle 14A travels past worksite 18, its location, speed and trajectory is measured by autonomous vehicles 10A and 10B. Vehicle 14A is travelling at a safe speed and at a safe distance from the worksite, so an alert is not created. As vehicle 14B approached the worksite 18, its location, speed and trajectory is measured by autonomous vehicles 10B and 10C. Vehicle 14B needs to move from its current lane into an adjacent lane in order to avoid colliding with the worksite. Each of the driverless traffic management vehicles 10 will be monitoring the speed and trajectory of vehicle 14B and checking for it to change lanes. If vehicle 14B does not move an emergency alert will be initiated.

Driverless traffic management vehicle 10C is monitoring vehicles 14B, 14C and 14D. Vehicle 14D is the only vehicle that is passing the worksite 18. Vehicle 14C has passed the worksite and no longer poses a great risk. However, vehicle 14C can still be monitored until some distance past the worksite 18 in case that vehicle does anything unusual such as makes a U-turn or passes over the highway to the other side and causes a road traffic accident that might then have flow on negative impact for an approaching vehicle on the other side.

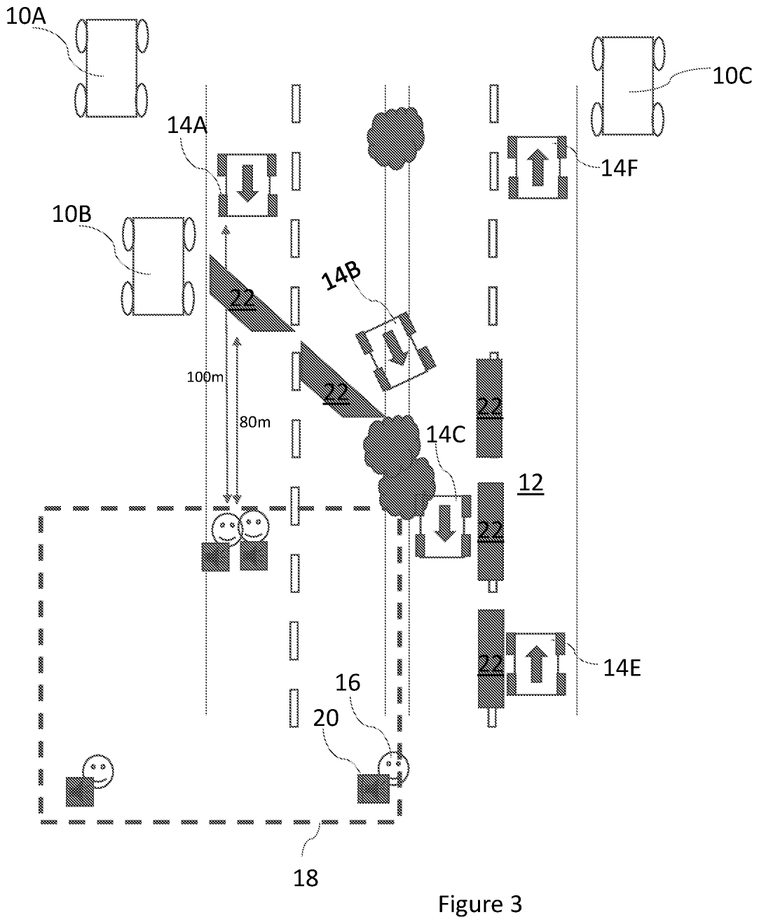

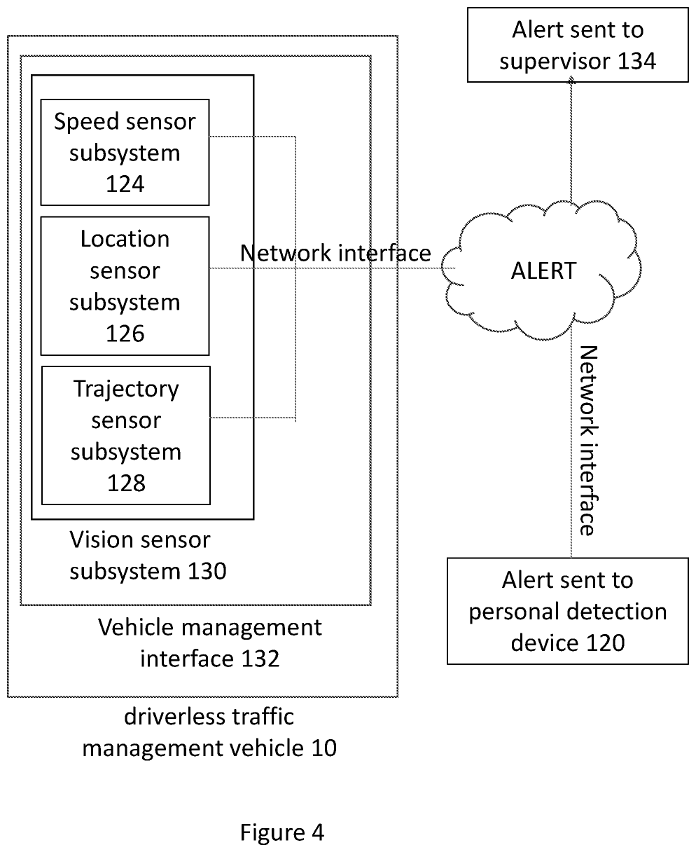

Referring now to FIGS. 3 and 4, the driverless traffic management vehicle 10 can comprise a location sensor subsystem 126. The location sensor subsystem 126 can detect the location of an approaching vehicle e.g. vehicle 14A. The location of vehicle 14A can be determined and then measured relative to the location of the worker(s) 16 as approximately 100 m. At the location of vehicle 14A, the vehicle cannot be closer than 80 m or an alert will automatically be initiated even if the vehicle is stationary. This is because, as can be seen in FIG. 3, there is a barrier 22 located at 80 m from the perimeter 18 and the workers 16. A vehicle 14 should not be on the inside of the barrier 22. Thus, in this embodiment, 80 m is a predetermined threshold value measured relative to the worker 16. The measurement relative to the worker in this instance can be the outermost location at which a worker 16 could be at the worksite 18. In other embodiments, the actual location of the worker 16 can be used (where they might not be at the perimeter of the worksite 18). Each location for a vehicle 14 will have a different threshold value calculable by the driverless traffic management vehicle 10 as either the distance from the barrier line 22 to the perimeter of worksite 18, the distance from the barrier line 22 to the closest worker 16, or as pre-programmed as some other distance by the site operator.

If a worker 16 moves outside of the perimeter of the worksite 18 and closer to the barrier line 22, then an alert is likely to be initiated by the driverless vehicle 10. The relative distance of the vehicle 14 and the worker 16 will decrease due to the worker's movement towards the barrier line 22. This unexpected decrease in distance would likely cause an alert 120 to be sent to the personal detection device 20. A supervisor might also receive an alert 134 which may enable them to make sure that workers 16 under their control are following guidelines.

The driverless traffic management vehicle can comprise a speed sensor subsystem 124. The speed sensor subsystem 124 can detect the speed of an approaching vehicle e.g. vehicle 14A in FIG. 3. If vehicle 14A is travelling at 100 kmph it might be that the driverless traffic management vehicle 10 makes an assessment that at this distance from the barrier line 22, the speed is excessive and an alert 120 is sent to worker(s) 16. If the distance of a speeding vehicle is greater than 300 m or 400 m (plus distance to worksite) then a speed of 100 kmph might be acceptable since the vehicle has time to slow down. Thus, in this embodiment, 100 kmph at 400 m (+distance to worksite) might be the predetermined threshold value measure relative to the worker 16.

The driverless traffic management vehicle can comprise a trajectory sensor subsystem 128. The trajectory sensor subsystem 128 can detect the trajectory of an approaching vehicle e.g. vehicle 14A in FIG. 3. The trajectory of the vehicle 14A will become important if it does not deviate to avoid the barrier line 22. Even if vehicle 14A is travelling at a reasonable speed of 50 kmph, it might be that the driverless traffic management vehicle 10 makes an assessment that at the current speed and trajectory, the vehicle is not going to turn at the barrier line 22 and a crash is imminent. If the vehicle is still travelling at 50 kmph at 2 or 3 m from the barrier line then an alert 120 is sent to worker(s) 16, so that they can assess and remediate the situation. Thus, in this embodiment, 50 kmph at 3 m (+distance to worksite) might be the predetermined threshold value measure relative to the worker 16.

The speed sensor subsystem 124, location sensor subsystem 126 and the trajectory sensor subsystem 128 can all be provided as part of a vision sensor subsystem 130, and be processed by a vehicle management interface 132 onboard the driverless traffic management vehicle 10. The vehicle management interface 132 also stores the predetermined threshold information set by the operator/user.

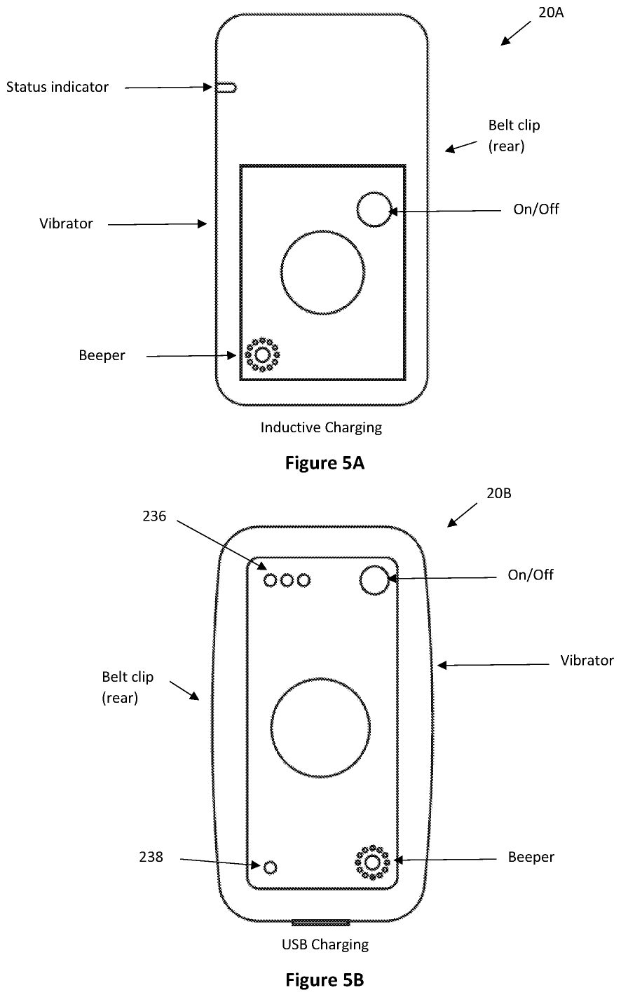

FIG. 5 shows two embodiments (FIG. 5A and FIG. 5B) of the personal detection device 20A and 20B which monitors workers and their positions. The device 20B comprises a series of status LEDs 236 which let the user know when the device is activated and/or when the device requires e.g. charging. Each of the personal detection devices 20A, 20B have a clip or strap for mounting on the user's belt or arm (not shown).

A visual alert can be by flashes of coloured lights from alert LED 238. The colours can show escalating risk if required. For example, a red flashing LED light 238 can indicate that there is an immediate danger such as vehicle 14A has breached the predetermined threshold values, and the worker 16 needs to stop what they are doing and check their surroundings. An amber flashing LED light 238 can indicate that there may be a danger such as vehicle 14B in FIG. 2 which is approaching at speed, but further assessment is being made, so the worker 16 should be ready to take action. A green flashing LED light 238 can mean that there is no danger and may be provided (optionally) if the worker 16 wishes to seek reassurance that there are no risks to safety being indicated from the driverless traffic management vehicles.

Where the alert is audible, the sound can be beeps or sirens or other ringing tones that attract attention. The user can select a sound that can be heard over background noises. The sound can change according to the present risk. For example, short alarming intermittent beeps can indicate that there is an immediate danger and the worker needs to stop what they are doing and check their surroundings. A series of longer beeps can indicate that there may be a danger, but further assessment is being made, so the worker should be ready to take action. A beep can be emitted every 5, 10, 15 minutes if preferred, which can confirm that there is no danger. This optional reassurance beep can be set if the worker wishes to seek reassurance that there are no risks to safety being indicated from the driverless traffic management vehicles

The alert can be a vibration. The vibration can complement the visual and audible beep. The vibration can be useful if the worker is in an area that is noisy and/or where they cannot see the device. The vibration should be transferred to the worker's body to get their attention. The intensity of the vibration can change according to the present risk. For example, intense and persistent vibrations can indicate that there is an immediate danger and the worker needs to stop what they are doing and check their surroundings. A soft intermittent vibration can indicate that there may be a danger, but further assessment is being made, so the worker should be ready to take action. A short soft vibration can be emitted every 5, 10, 15 minutes if preferred which can mean that there is no danger. This optional reassurance vibration can be set if the worker wishes to seek reassurance that the device is working properly, and that there are no risks to safety being indicated from the driverless traffic management vehicles.

When arriving at the worksite, the worker 16 will be assigned their personal detection device 20. The worker 16 should check the device for faults and full charge. Assuming the device is operating, the worker 16 can go about their business. If an alert 120 sounds, the worker 16 can check their device and take appropriate action. A log of alerts might be kept for the site manager, so that frequently occurring incidents or dangerous worksites or workers most often in danger can be recognised.

When setting up the autonomous driverless traffic management vehicle 10, the site operator can decide how many units will be deployed. The driverless traffic management vehicles 10 can then be taken to their starting locations. The predetermined threshold data can be programmed into the machines 10. An operator's control panel (OCP) can be used to simulate the worksite 18 and help guide the operator to decide on predetermined threshold values. For example, using a map, the control panel might suggest that for a worksite 18 of the size provided in meters, with fifteen workers 16 where the speed limit is 50 kmph and a barrier line at 20 m, a distance of 5 meters to the perimeter of the worksite is appropriate for a red alert and a speed of kmph should always initiate a warning. The skilled person will be able to determine what values should be selected based on the teachings of this document. In preferred embodiments, the invention does not lie in the selection of the parameters, but in the surprising finding that traffic risk management systems are not always successful when the vehicle that poses the risk is not an owner operated vehicle to which hardware can be attached to monitoring its location.

### Standard Paragraphs

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM. Furthermore, a computer-readable carrier medium may form, or be included in a computer program product. A computer program product can be stored on a computer usable carrier medium, the computer program product comprising a computer readable program means for causing a processor to perform a method as described herein.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium.

The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose.

Terms such as “forward”, “rearward”, “radially”, “peripherally”, “upwardly”, “downwardly”, and the like are used as words of convenience to provide reference points and are not to be construed as limiting terms.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

It is to be understood that, if any prior art publication is referred to herein, such reference does not constitute an admission that the publication forms a part of the common general knowledge in the art, in Australia or any other country.

Any promises made in the present description should be understood to relate to some embodiments of the invention, and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. A traffic risk management system for monitoring vehicles relative to one or more workers, the system comprising:
a driverless traffic management vehicle for detecting one or more of a location, speed and trajectory of an approaching vehicle,
a personal detection device mountable on the or each worker and configured to receive a signal from the driverless traffic management vehicle,
wherein the driverless traffic management vehicle sends an alert to the personal detection device mounted on the or each worker if the detected location, speed and/or trajectory of the approaching vehicle exceeds a predetermined threshold value measured relative to the or each worker.

2. The traffic risk management system of claim 1, wherein the driverless traffic management vehicle is a land-based vehicle.

3. The traffic risk management system of claim 1, wherein the system comprises more than one driverless traffic management vehicle.

4. The traffic risk management system of claim 3, wherein there is at least one driverless traffic management vehicle for every 100, 200, 300, 400 or 500 m3 of worksite.

5. The traffic risk management system of claim 1, wherein in use more than one driverless traffic management vehicle is deployed at a spacing of between about 100 m to 500 m between driverless traffic management vehicles.

6. The traffic risk management system of claim 1, wherein in use the driverless traffic management vehicle is deployed at a distance of between about 100 m to 1,000 m from the closet worker.

7. The traffic risk management system of claim 1, wherein each driverless traffic management vehicle is assigned a zone in which it may operate, and it does not pass the virtual borders of that zone during deployment.

8. The traffic risk management system of claim 1, wherein each driverless traffic management vehicle is programmed with a route configuration.

9. The traffic risk management system of claim 1, wherein each driverless traffic management vehicle comprises a vision sensor subsystem.

10. The traffic risk management system of claim 9, wherein the vision sensor subsystem comprises side facing cameras so as to view sideways from the driverless traffic management vehicle at the road verge.

11. The traffic risk management system of claim 9, wherein the vision sensor subsystem comprises forward-facing camera but wide angled so as to be able to view the road verge and other indica at differing offsets.

12. The traffic risk management system of claim 1, wherein the driverless traffic management vehicle detects a location of an approaching vehicle and wherein the driverless traffic management vehicle comprises a location sensor subsystem to detect the location of the approaching vehicle.

13. The traffic risk management system of claim 1, wherein the driverless traffic management vehicle detects a speed of an approaching vehicle and wherein the driverless traffic management vehicle comprises a speed sensor subsystem to detect the speed of the approaching vehicle.

14. The traffic risk management system of claim 1, wherein the driverless traffic management vehicle detects a trajectory of an approaching vehicle and wherein the driverless traffic management vehicle comprises a trajectory sensor subsystem to detect the trajectory of the approaching vehicle.

15. The traffic risk management system of claim 1, wherein the personal detection device is configured to indicate the location of the device based on one or more of a gyroscope measurement, inertial sensor measurement and a GPS signal.

16. The traffic risk management system of claim 1, wherein the alert comprises at least one of beeps of sound, flashes of light and vibration.

17. A method of monitoring the health and safety of workers located at a worksite adjacent to traffic, the method comprising the steps of:
a. programming or causing to have programmed one of more driverless traffic management vehicles to detect traffic hazards in the vicinity of the worksite;
b. deploying the said one or more driverless traffic management vehicles in the vicinity of the worksite;
c. allowing an alert to be initiated by one or more of the driverless traffic management vehicles during use if a traffic hazard is detected based on its programming; and
d. providing workers with a personal detection device configured to receive the alert issued by the one or more of the driverless traffic management vehicles.

18. A driverless traffic management vehicle when used in the system of claim 1.

19. A personal detection device when used to receive an alert from the driverless traffic management vehicle according to claim 18.
